(19) United States
(12) Patent Application Publication
(10) Pub. No.: US 2023/0258272 A1
(43) Pub. Date: Aug. 17, 2023

(54) CHECK VALVE

(71) Applicant: TI Automotive Technology Center GmbH, Rastatt (DE)

(72) Inventors: Albert BOECKER, Ettlingen (DE); Matthias WINTER, Rastatt (DE); Thorsten SCHAEFER, Steinfeld (DE); Florian DEIBEL, Sinzheim (DE)

(21) Appl. No.: 18/015,009

(22) PCT Filed: Jun. 29, 2021
(86) PCT No.: PCT/EP2021/067897

§ 371 Date: Jan. 6, 2023

(30) Foreign Application Priority Data
Jul. 2, 2020 (DE) 20 2020 103 843.5

(51) Int. Cl. F16K 15/02; F16K 27/02

(52) U.S. Cl. CPC F16K 15/026; F16K 27/0209; B60L 58/26

(57) ABSTRACT

A check valve, comprising a first housing part, a second housing part and an insert, wherein a spring element and a valve body are formed from the insert, wherein a valve seat is formed from the first housing part, wherein the first housing part and the second housing part have a connecting element for connection to a fluid line, wherein the insert is formed from injection-moldable plastic, and a coolant circuit comprising a coolant guide and at least one check valve, and an electric vehicle comprising a coolant circuit.

### RELATED APPLICATIONS

The present disclosure is a national phase application of PCT Application PCT/EP2021/067897, filed Jun. 29, 2021, which claims priority to German Application DE 20 2020 103 843.5, filed on Jul. 2, 2020, the entire contents of which is incorporated herein by reference.

### FIELD

The disclosure relates to a check valve comprising a first housing part, a second housing part and an insert, wherein a spring element and a valve body are formed from the insert, wherein a valve seat is formed from the first housing part, wherein the first housing part and the second housing part have a connecting element for connecting to a fluid line.

### BACKGROUND

Check valves are generally known and are used, for example, in fluid circuits, wherein fluid circuits are understood to mean, in particular, cooling circuits and air-conditioning circuits in which a coolant circulates. Check valves allow fluid to flow in one direction only and shut off fluid flow in the opposite direction. This can, for example, prevent fluid from flowing back when units are switched off. Furthermore, check valves can be used to direct fluid flows in more complicated fluid circuits.

In the case of coolant circuits, the demands on the check valve materials are comparatively low. Therefore, it is also known to form individual components of the check valve from plastic. However, the components of the insert, the spring element and the valve body, are usually formed separately from each other and the spring element is usually made of metallic material.

Electric vehicles have components whose temperature must be controlled by a coolant circuit. Batteries, for example, must be cooled or heated depending on their use and ambient temperature. The batteries especially limit the space and weight available for other components, such as components of the coolant circuit.

The disclosure is based on the task of providing a check valve which can be manufactured at low cost.

This task is solved by the features of claim 1. The subclaims refer to advantageous embodiments.

The check valve according to the disclosure comprises a first housing part, a second housing part and an insert, wherein a spring element and a valve body are formed from the insert, wherein a valve seat is formed from the first housing part, wherein the first housing part and the second housing part have a connecting element for connecting to a fluid line, wherein the insert is formed from injection-moldable plastic.

### BRIEF SUMMARY

According to the disclosure, both the spring element and the valve body are made of injection-moldable plastic and can thus be manufactured at particularly low cost. The check valve according to the disclosure is particularly suitable for use in a coolant guide, wherein a coolant, for example cooling water, flows through the coolant guide. The spring element automatically presses the valve body against the valve seat so that the direction of flow starting from the spring element in the direction of the valve body is blocked for the coolant. In the opposite direction, on the other hand, the coolant can flow through the check valve, provided that the feed pressure of the coolant is so high that the valve body is spaced apart from the valve seat against the force of the spring element. The fact that the spring element is made of plastic means that the auxiliary energy required for this is comparatively low. In addition, it has been shown that when the check valve is used in a coolant guide, the demands on the spring element are comparatively low, so that even when an injection-moldable plastic is used, a check valve with a long service life can be created. Furthermore, it is advantageous that plastics are corrosion resistant. This is particularly advantageous in connection with applications in electromobility. In the case of batteries, it is possible that electrolyte may enter the cooling circuit in the event of damage. The plastic insert can be made of a plastic that is resistant to such electrolytes.

A retaining body can be formed from the insert, which is supported on the second housing part. The retaining body preferably has a passage through which the coolant can flow. For this purpose, the retaining body can be ring-shaped, for example. The retaining body is supported on the second housing part, thereby causing the spring element to press the valve body securely against the valve seat.

The insert with spring element, valve body and retaining body can be formed in one piece and in a materially integral manner. In this embodiment, the check valve has only three separate components: the first housing part, the second housing part, and the insert. As a result, the check valve has a particularly simple design and can be manufactured cost-effectively in large quantities. The injection molding process is particularly suitable for manufacturing the components of the check valve. In this context, it is particularly advantageous if the first housing part and/or the second housing part are formed from injection-moldable plastic. In particular, it is conceivable to use polypropylene (PP) or polyamide (PA) as the injection moldable plastic. If higher coolant temperatures are expected, the use of polyoxymethylenes (POM) is particularly advantageous.

The housing parts can be connected to each other in a positive or force-fitting manner or in a substance-to-substance bond. In particular, it is conceivable to join the housing parts using a welding process, such as laser welding. Alternatively, the housing parts can be connected to each other in a positive/force-fitting manner via a snap-on connection.

The valve seat can have a sealing body associated with it, which is preferably made of thermoplastic material. In terms of simple and cost-effective manufacturability, it is advantageous if the sealing body is made of thermoplastic material. In this design, the sealing body can be molded together with the first housing part in the course of two-component injection molding.

When all components of the check valve are designed using the injection molding process, the check valve can be manufactured in a wide variety of shapes, so that the check valve can be adapted particularly well to the available space of a coolant circuit of an electric vehicle.

A guide element can be formed from the insert. The guide element causes the valve body to be evenly spaced from the valve seat during opening and to perform a directed movement during opening. This is particularly advantageous in connection with the spring element formed of plastic, which has a comparatively low holding force. The guide element is preferably arranged on the side of the valve body facing away from the spring element. The guide element can be supported in sections on the inner wall of the first housing part. Furthermore, the guide element can be formed from the insert in a materially integral manner. The fact that the guide element is arranged on the side of the valve body facing away from the spring element makes it possible to manufacture the insert by injection molding at low cost. In this context, it is particularly conceivable that the spring element is designed as a spiral spring, which has a particularly good spring effect. The spring element can also comprise several spiral springs, which are connected in parallel and/or in series. Because the spring element is made of plastic, the spring constant is relatively small. The spring constant can be increased by connecting several springs in parallel. In the case of spiral springs, this can be achieved by nesting several spiral springs inside each other. It is also conceivable to design a multiple spiral spring, for example in the form of a double or triple spiral spring.

The connecting elements can be formed as pipe sockets. This allows the check valve to be integrated into a pipe arrangement of a cooling circuit for example. Both pipes and hoses can be attached to the pipe sockets. The pipes or hoses can be connected to the pipe socket by a pipe clamp, or with a substance-to-substance bond by a welded connection. Alternatively, the connecting elements can be designed as quick connectors. Advantageous quick connectors are known, for example, from EP 2 796 758 A1 or EP 3 364 090 A1.

A cooling circuit according to the disclosure comprises a coolant guide and at least one check valve according to the disclosure. Preferably, the check valve can be part of a coolant circuit of a cooling system of an electric vehicle. The cooling system is used to control the temperature of key components of the electric vehicle such as batteries, electric motors, power electronics, charging adapters and plug connections. For use in a cooling system of an electric vehicle, it is particularly advantageous that the check valve according to the disclosure is, on the one hand, especially light and, on the other hand, consists entirely of electrically insulating or electrically non-conductive components.

### BRIEF DESCRIPTION OF THE DRAWINGS

An exemplary embodiment of the check valve according to the disclosure is explained in more detail below with reference to the Figure. It shows schematically:

FIG. 1 a check valve in partial section.

### DETAILED DESCRIPTION

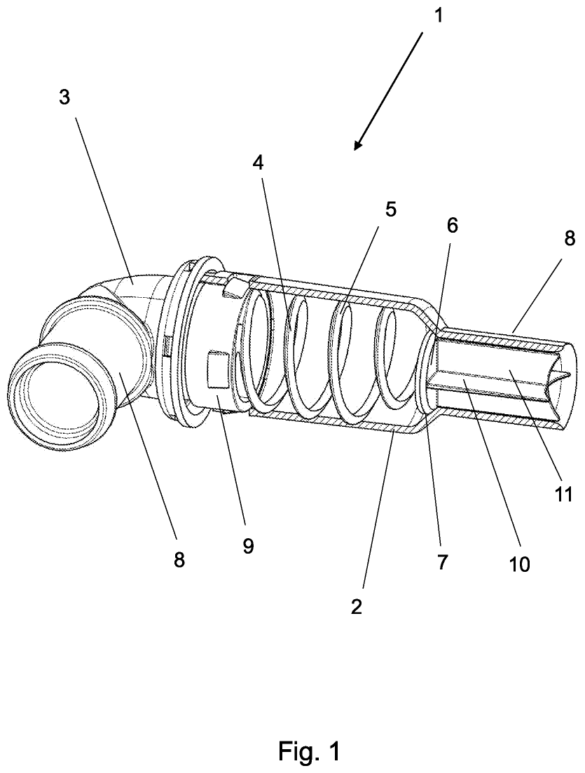

FIG. 1 shows a check valve 1 comprising a first housing part 2, a second housing part 3 and an insert 4. A spring element 5 and a valve body 6 are formed from the insert 4, and a valve seat 7 is formed from the first housing part 2. The first housing part 2 and the second housing part 3 have connecting elements 8 in the form of pipe sockets for connection to fluid lines, for example pipes or hoses.

A retaining body 9 is formed from the insert 4, which is supported on the second housing part 3. Furthermore, a guide element 10 is formed from the insert 4, wherein the guide element 10 is supported in sections on the inner housing wall of the first housing part 2.

The valve body 6 is disc-shaped and has a conically shaped peripheral edge, wherein the peripheral edge rests in a sealing manner on the valve seat 7, which is shaped congruently with the valve body 6. The spring element 5 is designed as a spiral spring and is attached centrally to the valve body 6. In the present embodiment, the spiral spring is formed as a single spiral spring. In alternative embodiments, the spiral spring can also be a multiple spiral spring, for example a double or triple spiral spring. The guide element 10 is in turn arranged on the side of the valve body 6 facing away from the spring element 5.

The guide element 10 is supported in sections on the inner housing wall of the first housing part 2. The guide element 10 has bridges 11 that are arranged in a cross-shaped manner relative to one another, which are attached at the end face to the side of the valve body 6 facing away from the spring element 5. The bridges 11 can thereby come into contact with the radial outer edges on the inner housing wall of the first housing part 2 and thereby support the valve body 6.

The insert 4 with spring element 5, valve body 6, retaining body 9 and guide element 10 is made in one piece in a materially integral manner from injection-moldable plastic. In the present embodiment, the insert 4 is made of POM. Furthermore, the first housing part 2 and the second housing part 3 are made of injection-moldable plastic and are also made of POM.

The check valve 1 shown in the Figure is part of a coolant circuit of a cooling system of an electric vehicle. The cooling system is used to control the temperature of key components of the electric vehicle such as batteries, electric motors, power electronics, charging adapters and plug connections.

In an alternative embodiment, the check valve 1 shown in the FIGURE is part of an air conditioning circuit of an air conditioning system. In this context, the air conditioning system is preferably used to provide air conditioning for a vehicle.

If the same pressure prevails on both sides of the valve body 6, the valve body 6 is in sealing contact with the valve seat 7. In doing so, the valve body 6 is pressed against the valve seat 7 by the force of the spring element 5. Fluid flowing over the spring element 5 in the direction of the valve body 6 is blocked by the valve body 6. A fluid flowing from the direction of the guide element 10 toward the valve body 6, on the other hand, can lift the valve body 6 from the valve seat 7 if the force exerted on the valve body 6 by the pressure of the fluid is greater than the force of the spring element 5. In this case, the valve body 6 lifts off the valve seat 7, wherein the valve body 6 is evenly spaced apart from the valve seat 7 due to the guide element 10 and exposes an annular gap. The annular gap allows the fluid to pass through the valve body 6 and flow through the check valve 1. The fact that the guide element 10 is bridge-shaped means that the fluid flow in this area is only slightly impaired.

1. A check valve, comprising:
a first housing part;
a second housing part; and
an insert formed from injection-moldable plastic, wherein a spring element and a valve body are formed from the insert,
wherein a valve seat is formed from the first housing part, and
wherein the first housing part and the second housing part have a connecting element for connection to a fluid line.

2. The check valve according to claim 1, wherein a retaining body is formed from the insert, which is supported on the second housing part.

3. The check valve according to claim 2, wherein the insert with spring element, valve body and retaining body is formed in one piece and in a materially integral manner.

4. The check valve according to claim 1, wherein the first housing part and/or the second housing part are formed from injection-moldable plastic.

5. The check valve according to claim 1, wherein the housing parts are connected to one another in a form-fitting or force-fitting manner and/or with a substance-to-substance bond.

6. The check valve according to claim 1, wherein a guide element is formed from the insert.

7. The check valve according to claim 6, wherein the guide element is supported in sections on the inner housing wall of the first housing part.

8. The check valve according to claim 6, wherein the guide element is formed in one piece and in a materially integral manner from the insert.

9. The check valve according to claim 1, wherein the spring element comprises at least one spiral spring.

10. The check valve according to claim 1, wherein the connecting elements are formed as pipe sockets.

11. The check valve according to claim 1, wherein the connecting elements are formed as quick connectors.

12. The check valve according to claim 1, wherein pipes are connected to the connecting elements in a substance-to-substance bond.

13. A coolant circuit comprising a coolant guide and at least one check valve according to claim 1.

14. An electric vehicle comprising a coolant circuit according to claim 13.
